(19) United States
(12) Patent Application Publication
(10) Pub. No.: US 2009/0217057 A1
(43) Pub. Date: Aug. 27, 2009

(54) Download And Burn To Rent System

(75) Inventor: David Konetski, Austin, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 12/037,759

(22) Filed: Feb. 26, 2008

(51) Int. Cl. H04L 9/06

(52) U.S. Cl. 713/193

(57) ABSTRACT

A system and method provide for content to be downloaded by an information handling system (IHS) and written to an optical storage medium. The content is protected by a content protection system. The content on the storage medium may be decrypted and displayed by a playback device. An invalid credential is written to the storage medium, for example, after display of the content. The invalid credential restricts decryption of the content. Examples of credentials that may be invalidated by writing an invalid credential to the storage medium include any keys, usage rules, or other items required for the decryption of content, for example, under content scrambling system (CSS) or advanced access content system (AACS) content protection systems.

### BACKGROUND

The present disclosure relates generally to information handling systems, and more particularly to providing temporary use (e.g., rental) of downloaded content written to an optical storage medium.

As the value and use of information continues to increase, individuals, and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Today, digital distribution of content such as, video content, is not only feasible but a basis of the business model of numerous entities. However digital distribution is not yet competitive with distribution of video content by more traditional methods of distribution, for example, the sale or rental of a DVD. This is especially true in the rental of video content. Conventional offerings of rental of video content provided by digital distribution require that the video content be locked to the IHS (e.g., personal computer) to which it was downloaded. This limits the consumer in terms of the manner and location in which he can enjoy the content.

Accordingly, it would be desirable to provide for temporary ownership (e.g., rental) of digitally distributed content.

### SUMMARY

According to one embodiment, content is downloaded to an IHS. The content is protected by a content protection system. Necessary credentials associated with the content protection system are obtained by the IHS. The content protection system and associated credentials allow for the content to be written to an optical storage medium and decrypted and displayed by a playback device. After display using a playback device, an invalid credential is written to the optical storage medium such that it overwrites at least one credential used to decrypt the content. As such, the invalid credential invalidates the storage medium by preventing a playback device from displaying the content. Thus, a temporary use of content written on a storage medium for use in a playback device is provided to a user.

### BRIEF DESCRIPTION OF THE DRAWINGS

FIG. 1 is a schematic view of an embodiment of an IHS.

FIG. 2 is a flowchart illustrating an embodiment of a method of providing temporary use of downloaded content written to an optical storage medium.

FIG. 3 is a schematic view of an embodiment of a system providing temporary use of downloaded content written to an optical storage medium.

FIG. 4 is a flowchart illustrating an embodiment of a method of providing temporary use of content written to an optical storage medium using a content protection system including a Content Scramble System (CSS).

FIG. 5 is a flowchart illustrating an embodiment of a method of providing temporary use of content written to an optical storage medium using a content protection system including an Advanced Access Content System (AACS).

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device (e.g., a DVD recorder, a Blu-Ray recorder), a network server or storage device, a switch router or other network communication device, or any other suitable device and may vary in size, shape, performance, functionality, and price. The IHS may be a consumer electronic device, such as a storage medium recorder (e.g., DVD recorder or Blu-Ray recorder) with internet connectivity. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

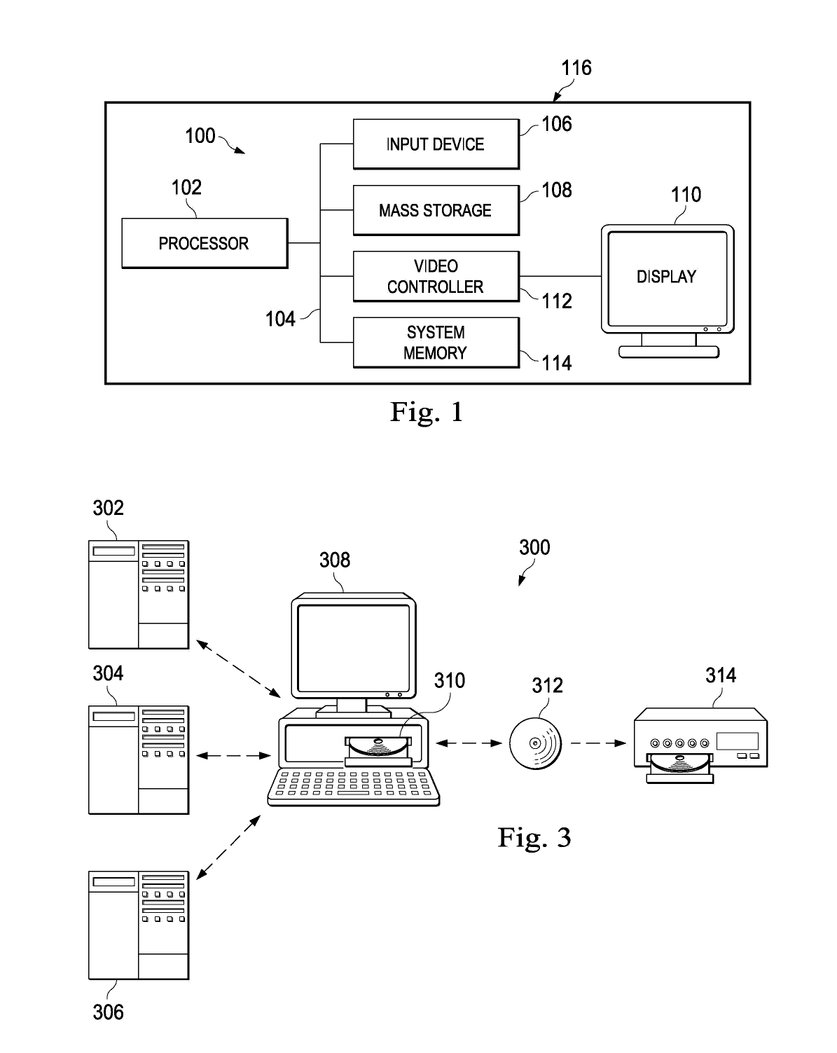

In one embodiment, IHS 100, FIG. 1, includes a processor 102, which is connected to a bus 104. Bus 104 serves as a connection between processor 102 and other components of computer system 100. An input device 106 is coupled to processor 102 to provide input to processor 102. Examples of input devices include keyboards, touchscreens, and pointing devices such as mouses, trackballs, and trackpads. Programs and data are stored on a mass storage device 108, which is coupled to processor 102. Mass storage devices include such devices as hard disks, optical disks, magneto-optical drives, floppy drives, optical disk drives including readers and recorders (e.g., burners, writers), and the like. The mass storage device include computer-readable medium. IHS 100 further includes a display 110, which is coupled to processor 102 by a video controller 112. A system memory 114 is coupled to processor 102 to provide the processor with fast storage to facilitate execution of computer programs by processor 102. The system memory may include computer-readable instructions for executing actions by the processor 102. In an embodiment, a chassis 116 houses some or all of the components of IHS 100. It should be understood that other buses and intermediate circuits can be deployed between the components described above and processor 102 to facilitate interconnection between the components and the processor 102.

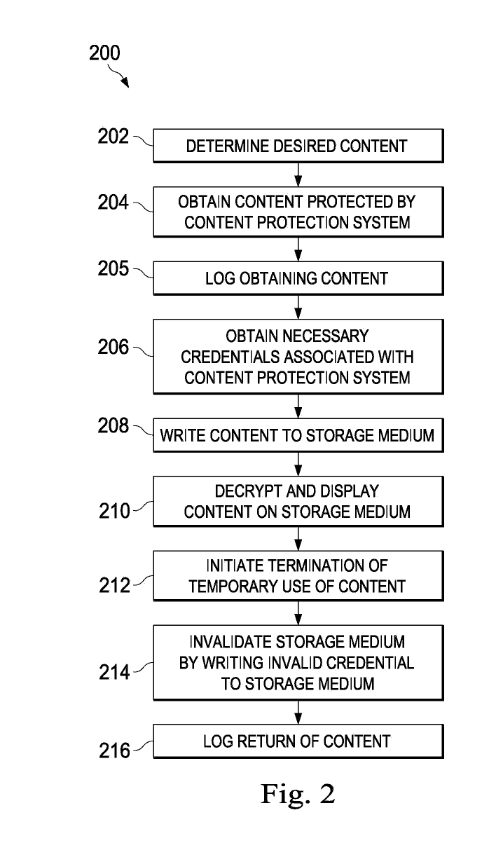

Referring now to FIG. 2, illustrated is a flowchart of an embodiment of a method 200 of providing temporary use of content obtained by an IHS and written to an optical storage medium. The method 200 may provide a download to burn rental method. In other words, the method 200 may allow a user temporary use (e.g., “rent”) of content downloaded by an IHS. The method 200 allows the content to be written (e.g., burned) to a storage medium for use with a playback device that may be distinct from the downloading IHS, and subsequently provides for rendering the content written to the storage medium unusable. Therefore, only temporary use (e.g., “rent”) of the content is provided to a user. It should understood that additional steps may be provided before, during, and after the method 200, and some of the steps described below can be replaced or eliminated, for additional embodiments of the method. The method 200 is described herein as providing for writing, by an optical storage device, content to an optical storage medium; however, other embodiments may be possible.

The method 200 begins at block 202 where the desired content is determined. In an embodiment, a user (e.g., consumer) determines a desired content for example, from a variety of available content. The desired content may be selected by a user using a provided web page. The content may include video and/or audio content. Examples of content may include, for example, a movie, a movie trailer, a song, a music video, a television show, an advertisement, a recordation of an event such as, a sporting event, an audio recording, and/or other possible content including that for entertainment and/or educational purposes.

The method 200 then proceeds to block 204 where a user obtains the content. The content may be downloaded to an IHS (e.g., a client) such as the IHS 100, described above with reference to FIG. 1. The content may be protected by a content protection system (e.g., protected and/or encrypted content). The content may be protected by a content protection system when downloaded and/or be protected by the IHS. The content protection system provides for encryption/decryption of the content, including providing a user ability to write the content to a storage medium and providing for decryption of the content by a playback device. The content protection system may include a variety of digital rights management (DRM) schemes available in the art. Examples of content protection systems include CSS and AACS, though other embodiments of content protection systems may be possible.

The method 200 then proceeds to block 205 where a reporting system (e.g., an IHS including software provided thereon) logs the user's obtaining of the content. In an embodiment, a log entry is generated by the server from which the content was downloaded. The log entry may be used to determine a rental period and/or a payment owed by a user.

The method 200 then proceeds to block 206 where necessary credentials associated with the content protection system are obtained. The credential(s) obtained may be referred to herein as “valid” credentials, or credentials that allow for successful decryption and/or use of protected content. In an embodiment, an IHS (e.g., a client IHS) obtains (e.g., downloads) the credentials from one or more IHSs (e.g., servers) distinct from the client IHS. The server(s) may be the same as or distinct from the server from which the content was downloaded. Credentials associated with a content protection system include any credential, for example, key, usage rule, and/or other item, that is included in the hierarchy of decryption of the protected content (i.e., that is used in the decryption of the content). Examples of credentials include, for example, a license key, a title key, a disc key, a prepared video token, a media key block, usage rules, and/or other credentials associated with content protection systems. In an embodiment, the credentials are defined by the CSS and/or AACS specifications.

The method 200 then proceeds to block 208 where the content is written (e.g., burned) to an optical storage medium. The IHS may write the content onto the optical storage medium using an optical mass storage device such as, for example, the mass storage device 108, described above with reference to FIG. 1. In an embodiment, the content is written using an optical disc drive capable of recording. Examples of optical storage media include laserdisc, compact disc (CD), MiniDisc, DVD, HD DVD, Blu-ray Disc (BD), ultra density optical (UDO), universal media disc (UMD), and/or other data storage devices. In an embodiment, the optical storage medium is a rewritable storage medium such as, for example, CD-RW, DVD−RW, DVD+RW, DVD-RAM, BD-RE, HD DVD−RW, HD DVD-RAM, and/or other rewritable data storage devices. One or more credentials associated with a content protection system may be written to the optical storage medium. The credential written to the optical storage medium in block 208 may be valid credentials providing for the decryption of the content. The credentials written to the optical storage medium may be used by the playback device to decrypt the content. The playback device may include one or more credentials (e.g., device key, sequence key) also associated with the content protection system that may be used in the decryption of the content. In an embodiment, the optical storage medium is purchased by a user having credentials used in the decryption; the credentials allowing for the writing of content that is to be displayed by a playback device. Examples of such credentials included on an optical storage medium include a disc key set (e.g., CSS Recordable DVD with a pre-recorded secured disc key set), a recordable medium ID, a binding nonce, and/or other credentials provided on storage media. The manner and details of writing content and credentials to an optical storage medium and decryption of the content by a playback device may be readily appreciated by one skilled in the art, for example, under CSS or AACS schemes.

The method 200 then proceeds to block 210 where the content on the optical storage medium may be decrypted and/or displayed. For example, having completed the writing (e.g., burning) of content as described above with reference to block 208, the user may eject the optical storage medium from the IHS. The content of the optical storage medium may be displayed, including visual and/or audio display, by a playback device. The playback device may be distinct and separate from the IHS used above in blocks 204, 206 and/or 208. Examples of playback devices include DVD players, DVD recorders, CD players, CD/DVD drives associated with an IHS, and/or other devices operable to display content from an optical storage medium. A playback device may include an IHS such as, the IHS 100, described above with reference to FIG. 1. In an embodiment, a user displays the content of the storage medium on a plurality of playback devices. Any portion of time may pass in which the content is available on the optical storage medium for display by a playback device. In an embodiment, the playback device is a licensed playback device. For example, the playback device may be licensed to display CSS-encrypted and/or AACS-encrypted content.

The method 200 then proceeds to block 212 where a user initiates the termination of the temporary period of use of the content (e.g., ending of the rental period). In an embodiment, the user determines he no longer has a need and/or desire to maintain the content provided on the optical storage medium and determines to end the period of use. In an embodiment, the provider of the content determines a time period for use (e.g., a rental period). To end the rental period and “return” the content, the user may couple (e.g., insert) the optical storage medium to an IHS such as, the IHS 100, described above with reference to FIG. 1. The optical storage medium may be inserted in an optical mass storage device associated with the IHS such as, the mass storage device 108, described above with reference to FIG. 1. In an embodiment, the user re-couples the optical storage medium to the IHS that has provided the download of content as described above with reference to block 204; however, other embodiments are possible. For example, a user may “check-out” content (e.g., download), write (e.g., burn), and “return” content all from different IHSs.

In an embodiment, the user determines that he will permanently retain the content on the optical storage medium. In such an embodiment, the user may be charged an additional amount for the content as a result of his ownership, rather than rental, of the content. In the embodiment, the blocks 212, 214 and/or 216 may be omitted.

The method 200 then proceeds to block 214 where the optical storage medium is invalidated by writing to the optical storage medium, an invalid credential associated with the content protection system. An invalid credential (e.g., usage rule, key) may be written to the optical storage medium by an IHS using, for example, an optical mass storage device such as the mass storage device 108, described above with reference to FIG. 1. The invalid credential may overwrite a credential previously obtained (e.g., a valid credential), for example, as described above with reference to block 206. The invalid credential may be written to a rewritable portion of the optical storage medium. The invalid credential may be associated with a credential used in the hierarchy of decryption of the content and as such, prevent decryption of the content. Thus, the invalid credential prevents decryption and/or displaying the content written to the optical storage medium, for example, by a playback device. Examples of credentials that may be invalidated (e.g., overwritten with an invalid credential) include a title key, a usage rule, a prepared video token (PVT), a media key block (MKB), and/or other possible credentials including CSS and AACS keys. The writing of an invalid credential to the optical storage medium, thus providing for inaccessible content, may be referred to as the “return” of content. In an embodiment, the optical storage medium is operable to be used again for example, for the storage of subsequently obtained content.

The method 200 then proceeds to block 218 where the return of the content is logged. A reporting system may log the return of content. The reporting system may be included in one or more IHSs (e.g., servers) from which the content was downloaded. A log entry providing receipt of the content, described above with reference to block 205, and a log entry providing the return of the content provide a rental period. In an embodiment, the return of the content and/or the rental period are used to determine a price to be paid by the user. In an embodiment, a website displays the rental period provided to the user. In an embodiment, a provider may obtain a form of payment such as, a credit card, prior to download of content. The payment may be made (e.g., the credit card charged) for the period of temporary ownership, or in the case of a user who does not “return” the content, for permanent ownership.

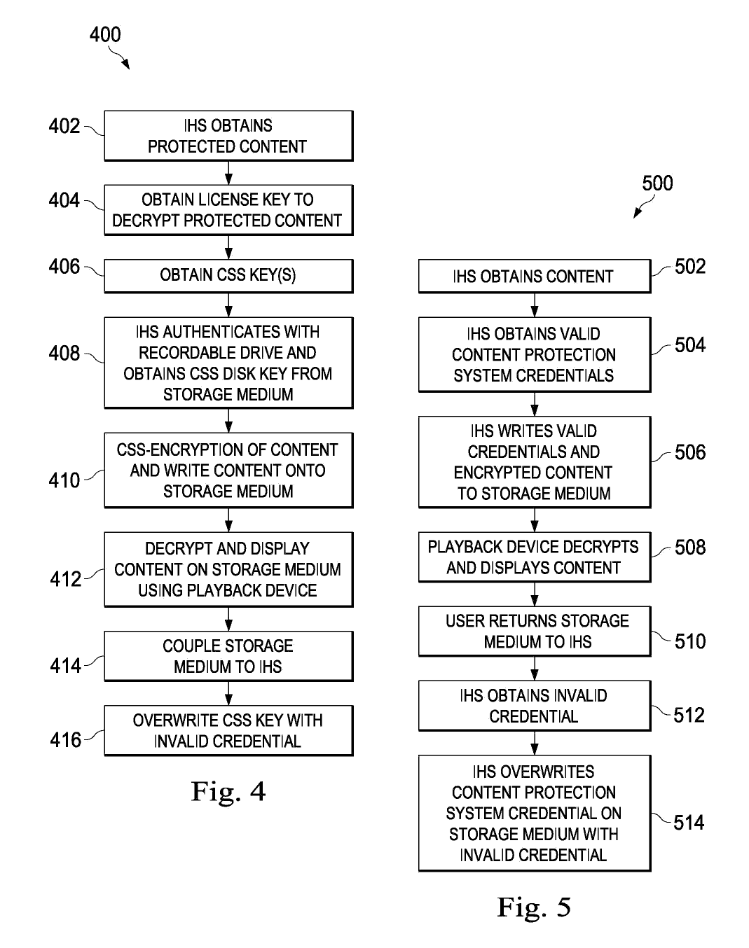

Referring now to FIG. 3, illustrated is a system 300 for providing temporary use (e.g., temporary “ownership”) of digital content written to a storage medium. The system 300 may be used to execute the method 200, described with reference to FIG. 2, and/or the methods 400 and 500, described with reference to FIGS. 4 and 5. The system 300 includes a plurality of servers 302, 304 and 306; an IHS 308 including an optical mass storage device 310; an optical storage medium 312, and a playback device 314. The plurality of servers 302, 304 and 306 are exemplary only and a single or any plurality of servers may be included in the system 300. The plurality of servers 302, 304 and 306 are operably coupled to the IHS 308. The plurality of servers 302, 304 and 306 may include IHS that provide for information, devices, programs, and the like be available to IHSs (e.g., client IHSs) on a network. The servers 302, 304 and 306 may be coupled to the IHS 308 using a computer network such as, for example, a Transport Control Protocol/Internet Protocol (TCP/IP) network (e.g., the internet or an intranet). Thus, the IHS 308 may be operable to obtain (e.g., download) information from one or more of the servers 302, 304 and 306. In an embodiment, the IHS 308 may download encoded and protected content from the server 302, a first credential associated with decrypting the content (e.g., a license key) from the server 304; and/or second credential associated with decrypting the content (e.g., a title key) from the server 306. However, any configuration of servers is possible.

The IHS 308 may be substantially similar to the IHS 100, described above with reference to FIG. 1. The optical mass storage device 310 may be substantially similar to the mass storage device 108, also described above with reference to FIG. 1. In an embodiment, the optical mass storage device 310 is a disc drive operable to write and re-write discs including HD-DVD, DVD, and/or Blu-ray discs. The optical storage medium 312 may include any form of media capable of recording and storing content. The optical storage medium 312 may be substantially similar to the storage media described above with reference to block 208 of FIG. 2. Including, in an embodiment, the optical storage medium is a rewritable optical storage medium such as, for example, a CD-RW, a DVD−RW, a DVD+RW, a DVD-RAM, a BD-RE, a HD DVD−RW, a HD DVD-RAM and/or other rewritable media type known in the art. Information, including content or content protection system items, may be written to the optical storage medium 312 by the optical mass storage device 310. In an embodiment, the optical storage medium 312 is inserted into the optical mass storage device 310 to be written.

The playback device 314 may be substantially similar to the playback device described above with reference to block 210 of FIG. 2. Including, for example, in an embodiment, the playback device may be a DVD player, a Blu-ray player, an HD-DVD player, and/or other device operable to display content written to a storage medium. The playback device 314 may include an IHS. In an embodiment, the playback device 314 is distinct from the IHS 308. For example, the playback device 314 may be a discrete device located a physical separation from and/or is not coupled to the IHS 308. In an embodiment, the playback device 314 is configured and/or licensed to decrypt content under CSS and/or AACS protection schemes.

Referring now to FIG. 4, illustrated is an embodiment of a method 400 of providing temporary use (e.g. rental) of downloaded content that is written to an optical storage medium under the CSS protection scheme. The method 400 may be an embodiment of the method 200, or portion thereof. The CSS protection scheme may allow downloaded content (e.g., a movie) to be written to a storage medium (e.g., a DVD); the content may be displayed by a playback device. It should understood that additional steps may be provided before, during, and after the method 400, and some of the steps described below can be replaced or eliminated, for additional embodiments of the method. For example, different, fewer and/or additional credentials may be obtained and used in the decryption/encryption of the content. One or more steps or portions thereof of the method 400 may be defined by a CSS-associated industry specification.

The method 400 begins a block 402 where encoded and protected content is downloaded to an IHS. The IHS receiving the content may be described hereinafter as the client. The client may be substantially similar to the IHS 100 and/or the IHS 308, described with reference to FIGS. 1 and 3, respectively. Described herein are exemplary embodiments providing a user (e.g., consumer) selects to download the content onto an IHS under his control, thereby establishing a client. However, one or more actions described herein may be performed by different users, automated systems, various IHS, and/or other possible entities. The content may be downloaded from a server such as, the server 302 described above with reference to FIG. 3, or other IHS.

The method 400 then proceeds to block 404 where a license key is obtained to decrypt the protected content. The client may obtain a license key from a server such as, the server 304, described above with reference to FIG. 3. In an embodiment, the server may be a DRM License Server. The method 400 then proceeds to block 406 where a CSS key, or plurality of keys, are obtained. In an embodiment, the CSS key(s) include a title key. One or more CSS keys are obtained from one or more servers, such as the server 306, described above with reference to FIG. 3. In an embodiment, a CSS key is obtained from a CSS Secure Media Recording Server. In an embodiment, additional credentials associated with the CSS content protection scheme are obtained by the client.

The method 400 then proceeds to block 408 where the client authenticates with an optical mass storage device to which it is coupled, and retrieves a credential associated with CSS scheme. In an embodiment, the client authenticates with a DVD recordable drive. The credential associated with the CSS scheme may be obtained from a storage medium (e.g., a DVD) provided in the mass storage device onto which content is to be written. In an embodiment, the IHS retrieves a CSS Disk Key from the storage media. In an embodiment, the storage medium is a CSS Recordable DVD and may include a pre-recorded Secured Disc Key Set.

The method 400 then proceeds to block 410 where an IHS (e.g., the client) provides CSS-encryption of the content. In an embodiment, an IHS uses the CSS Title Key and the CSS Disc Key to CSS-encrypt the content. The encrypted content may be written onto the optical storage medium by an IHS using an optical mass storage device. An encrypted title key may be written onto the optical storage medium. Additional embodiments of encryption and/or writing of content may be possible, including, for example, as described in a CSS-associated specification.

The method 400 then proceeds to block 412 where the content may be decrypted and displayed using a playback device. For example, the user may display the content using a playback device as described above with reference to block 210 of FIG. 2. The playback device may be a licensed CSS playback device, operable to decrypt CSS-protected content. Upon completion of use, the method 400 proceeds to block 414 where the optical storage medium is coupled to the client (e.g., re-inserted into the optical mass storage device). In an embodiment, the optical storage medium is inserted into a DVD recordable drive by a user.

The method 400 then proceeds to block 416 where an invalid credential is written to the optical storage medium. The invalid credential is written to a re-writable location on the optical storage medium. The invalid credential may overwrite one or more credentials obtained for example, in block 406, described above. The invalid credential invalidates (e.g., replaces) one or more credentials used to decrypt the content. For example, in an embodiment, a valid credential is obtained by the client and written onto the optical storage medium, as described above. The valid credential is used to decrypt the content. An invalid credential is subsequently obtained and written over the valid credential. Thus, although the optical storage medium retains the content, a playback device may be unable to decrypt and thus, display the content as proper (e.g., valid) credentials necessary in the decryption hierarchy are not present. As such, the user's temporary ownership period (e.g., rental) of the content is terminated. In an embodiment, any invalid CSS key may be written onto the optical storage medium. In an embodiment, an invalid title key is written onto the optical storage medium. The invalid credential may be obtained from a server such as, the servers 302, 304 and 305 described above with reference to FIG. 3, by an IHS. In an embodiment, the invalid credential is randomly generated. The invalid credential may be unique to the content and/or optical storage medium.

The method 400 may continue to provide for logging of the end of the rental period and/or obtaining monetary compensation from the user for the rental period, for example as described above with reference to the method 200 of FIG. 2.

Referring now to FIG. 5, illustrated is an embodiment of a method 500 of providing temporary use (e.g., rental) of downloaded content written to an optical storage medium under an AACS protection scheme. The method 500 may be an embodiment of the method 200, or portion thereof. An AACS protection scheme may allow downloaded content (e.g., a movie) to be written to an optical storage medium (e.g., an HD-DVD and/or Blu-Ray disc); the content may be decrypted and displayed by a playback device. It should understood that additional steps may be provided before, during, and after the method 500, and some of the steps described below can be replaced or eliminated, for additional embodiments of the method. For example, different, fewer, and/or additional credentials may be obtained and used in the decryption/encryption of the content. One or more steps or portions thereof of the method 500 may be defined by an AACS-associated industry specification.

The method 500 begins at block 502 where content may be obtained by an IHS (referred to hereinafter as a client). The IHS or client may be substantially similar to the IHS 100 and/or the IHS 308, described with reference to FIGS. 1 and 3, respectively. Furthermore, described herein are exemplary embodiments providing a user (e.g., consumer) selects to download the content onto an IHS under his control, thereby establishing a client. However, one or more actions described herein may be performed by different users, automated systems, various IHS, and/or other possible entities. The content may be downloaded from one or more servers such as, the servers 302, 304 and/or 306, described above with reference to FIG. 3. The obtained content may be encrypted using a content protection system credential, for example, a title key. The content may be encrypted by an IHS such as the client, and/or may be received by the client in encrypted form.

The method 500 then continues to block 504 where appropriate content protection system credentials are obtained. The client may receive the content protection system credentials from one or more servers such as, the servers 302, 304 and/or 306, described above with reference to FIG. 3. One or more of the credentials may be associated with the AACS content protection scheme. In an embodiment, a credential is obtained from the optical storage medium onto which content is to be burned. In an embodiment, a media ID and/or binding nonce may be obtained from an optical storage medium. Other examples of credentials that may be obtained include a media key block (MKB), a prepared video token (PVT), one or more usage rules, a title key (e.g., an encrypted title key), and/or other credentials known in the art including those described by industry specifications associated with AACS. The credentials may be used to decrypt the content. In an embodiment, a title key is received. In a further embodiment, the title key may be received from a Prepared Video Access Server. The encryption of the content and/or credentials may be performed by the client, a server, and/or other IHSs.

The method 500 then proceeds to block 506 where the IHS (e.g., client) writes the content to an optical storage medium. One or more of the credentials may also be written to the optical storage medium. The content and/or credentials may be written to an optical storage medium using an optical mass storage device such as, the mass storage device 108, described above with reference to FIG. 1. The optical storage medium may be an AACS-encoded recordable media. In an embodiment, the optical storage medium is a Blu-ray re-writable disc. In an embodiment, the optical storage medium is a re-writable HD DVD. The credentials (e.g., valid credentials) written to the optical storage medium provide for decryption of the content by a playback device.

The method 500 then proceeds to block 508 where the content may be decrypted and displayed using a playback device. For example, the user may display the content using a playback device substantially similar to as described above with reference to block 210 of FIG. 2. The playback device may be a licensed AACS playback device, operable to decrypt AACS-protected content. In an embodiment, the playback device is a Blu-Ray player. In an embodiment, the playback device is an HD DVD player. In an embodiment, the encrypted content, encrypted title key(s), volume ID, and MKB are read from the optical storage medium and used by the playback device to decrypt the content. The playback device may include device key(s) and sequence key(s) that are used to decrypt the content.

Upon completion of use of the content, the method 500 proceeds to block 510 where the storage medium is coupled to an IHS, for example, the client. In an embodiment, the storage medium is inserted into a recordable drive of the client IHS by a user. In alternative embodiments, the optical storage medium may be coupled to another IHS, for example, operably coupled to one or more servers such as, for example, the servers 302, 304 and/or 306 described above with reference to FIG. 3.

The method 500 then proceeds to block 512 where an invalid credential is written onto the optical storage medium. The invalid credential may overwrite the previous written, valid credential as described above with reference to block 506. The invalid credential is written to a re-writable location on the optical storage medium. The invalid credential invalidates (e.g., replaces) one or more credentials used to decrypt the content. Thus, although the optical storage medium retains the content, a playback device may be unable to decrypt and thus display the content as valid credentials required to decrypt the content are not present. That is a credential used in the decryption hierarchy is invalid. As such, the user's temporary ownership period (e.g., rental) of the content is ended. In an embodiment, any invalid AACS key may be written onto the optical storage medium. In an embodiment, an invalid title key is written onto the optical storage medium. The invalid credential may be obtained from a server such as, the servers 302, 304 and 305 described above with reference to FIG. 3. In an embodiment, the invalid credential is randomly generated. The invalid credential may be unique to the content and/or optical storage medium.

The method 500 may continue to provide for logging of the end of the rental period and/or monetary compensation from the user for the rental period, for example as described above with reference to the method 200 of FIG. 2.

Thus, provided are time efficient and cryptographically sound systems and methods in which to enable downloading of content and writing of the content to an optical storage medium where the user of the content is provided ownership over the content for a temporary duration (e.g., rental of the content). The methods and systems described herein include embodiments associated with Digital Rights Management schemes such as, CSS and AACS, though other embodiments provided within other content protection systems are possible and within the scope of the disclosure.

Conventional content protection schemes may provide the ability to revoke content or device keys, for example, if compromised or no longer valid. However, conventional revocation procedures would be unable to provide for a revocation on a wide-scale or efficient basis that would be necessary to support a download and burn to rent system that may offer a large quantity of content to a large number of consumers. For example, each transaction (e.g., rental of content) would need to be individually revoked on account of unique keys provided. This revocation would be time consuming of the consumer as well as the provider of the rental service.

Thus, provided is an efficient and effect system and method providing for rental of content downloaded and written to a storage medium, a download and burn to rent system and method. The rental period is terminated by writing an invalid credential to the storage medium. The invalid credential may be written to any re-writable portion of an optical storage medium and overwrites any credential used in the decryption of content (e.g., any credential required to be valid in order to decrypt the content). Thus, the optical storage medium is invalidated as the content is no longer displayable by a playback device as an item (e.g., credential) required in the decryption hierarchy is lacking. Obtaining and/or writing of the invalid credential is an efficient process providing this invalidation process may be easily completed by a user in less than a minute. In an embodiment, the system allows for over-writing a single credential. This increases efficiency, provides a shorter write time, and thus, increased user satisfaction over a system, for example, that over-writes the entire storage medium (e.g., including content).

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A method, comprising:
providing content, wherein the content is protected by a content protection system;
writing the content to an optical storage medium;
writing a valid credential associated with the content protection system to the optical storage medium; and
writing an invalid credential associated with the content protection system to the optical storage medium after the writing of the valid credential.

2. The method of claim 1, wherein the content protection system is associated with at least one of a content scrambling system (CSS) and an advanced access content system (AACS).

3. The method of claim 1, wherein the writing the invalid credential includes overwriting the valid credential with the invalid credential, wherein the valid credential is required to decrypt the content.

4. The method of claim 1, further comprising:
decrypting the content using the valid credential prior to the writing the invalid credential.

5. The method of claim 4, wherein the decrypting the content is performed by a playback device, wherein the writing the content is performed by an information handling system (IHS), and wherein the IHS and the playback device are distinct devices.

6. The method of claim 1, wherein the invalid credential is a credential selected from the group consisting of a media key block (MKB), a prepared video token (PVT), a usage rule, and a title key.

7. The method of claim 1, further comprising:
logging the writing of the invalid credential.

8. The method of claim 1, wherein the writing the invalid credential occurs after display of the content using a playback device.

9. The method of claim 1, wherein the providing the content includes a first IHS downloading the content from a second IHS, the second IHS operably connected to the first IHS.

10. The method of claim 1, further comprising:
receiving the invalid credential from a server.

11. The method of claim 1, wherein the storage media is rewritable disc selected from the group consisting of a DVD, an HD DVD, and a Blu-Ray disc.

12. The method of claim 1, further comprising:
generating a first log entry on the providing of the content;
generating a second log entry on providing of the invalid credential;
calculating a rental period using the first and second log entry; and
collecting a payment based on the rental period.

13. A computer-readable medium comprising computer-readable instructions to provide temporary use of content to a user, the computer-readable instructions comprising instructions to:
log a distribution of content to a user, wherein the content includes encrypted content;
provide an invalid credential to the user, wherein the invalid credential overwrites a credential required for decryption of the encrypted content; and
log the providing of the invalid credential.

14. The computer-readable medium of claim 13, further comprising computer-readable instructions comprising instructions to:
provide a credential used to decrypt the encrypted content.

15. The computer-readable medium of claim 13, further comprising computer-readable instructions comprising instructions to:
collect a payment from the user.

16. A system comprising:
a first information handling system (IHS) operable to obtain protected content, a valid credential, and an invalid credential;
a storage medium operably coupled to the first IHS, wherein content, the valid credential, and the invalid credential are written to the storage medium by the IHS; and
a reporting system, wherein the reporting system logs the writing of the invalid credential to the storage medium.

17. The system of claim 16, further comprising:
a playback device operable to decrypt the protected content using the credential.

18. The system of claim 16, wherein the first IHS is operably coupled to a second IHS, and wherein the content is downloaded from the second IHS to the first IHS.

19. The system of claim 16, wherein the storage medium includes a re-writable optical storage disc.

20. The system of claim 16, wherein the invalid credential overwrites a title key on the storage medium.
